(19) United States
(12) Patent Application Publication
(10) Pub. No.: US 2020/0262729 A1
(43) Pub. Date: Aug. 20, 2020

(54) Biological Fluidized Bed Process with High Concentration Powder Carriers Used for Treatment of Municipal Wastewater

(71) Applicant: Hunan Sanyou Environmental Technology Co., Ltd, Changsha City (CN)

(72) Inventors: Xiaoli Chai, Changsha City (CN); Yue Mu, Changsha City (CN); Jing Yi, Changsha City (CN); Zeheng Tang, Changsha City (CN); Hongbo Han, Changsha City (CN); Dan Hou, Changsha City (CN)

(21) Appl. No.: 16/794,678

(22) Filed: Feb. 19, 2020

(30) Foreign Application Priority Data
Feb. 20, 2019 (CN) 201910127562.5
Oct. 31, 2019 (CN) 201911051940.2

(51) Int. Cl. C02F 9/00

(52) U.S. Cl. CPC C02F 9/00; C02F 2003/001; C02F 2303/04

(57) ABSTRACT

The present invention relates in general to municipal wastewater treatment, and in particular, to a new biological fluidized bed process with high concentration powder carriers used for the treatment of municipal wastewater, wherein the process comprises: flowing the wastewater through a coarse screen and a lifting pump firstly, lifting to a fine screen and grit chamber, and then entering a HPB biochemical tank; dividing the HPB biochemical tank successively into an anaerobic zone, an anoxic zone, an aerobic zone and a concentrated separation zone along the flow direction of the wastewater, adding a compound powder carrier to the anaerobic zone, the anoxic zone and the aerobic zone respectively, and stirring and mixing into a mixture; flowing the mixture into the concentrated separation zone and concentrating and separating, returning the concentrate back to the anaerobic zone; discharging the supernatant from the concentrated separation zone and successively transporting through a high-efficient clarification tank, a filter tank and a disinfection tank to be purified; transporting the discharged excess sludge to a cyclone separation and recovery system; the separated compound powder carrier will be recycled to HPB biochemical tank. The HPB process in the present invention is a highly integrated municipal wastewater treatment process, in which only one lifting operation is required. In addition, it has a small land area, a low operating energy consumption and a high treatment efficiency.

### TECHNICAL FIELD

The present invention relates in general to municipal wastewater treatment, and in particular, to a new biological fluidized bed process with high concentration powder carriers used for the treatment of municipal wastewater.

### BACKGROUND

The discharge standard of wastewater treatment plants in the most areas of China is first class B of “Discharge standards of pollutants for municipal wastewater treatment plant” (GB18918-2002). Recently, the discharge standard is raising to first class A in many regions, and some more stricter local discharge standards are being issued, such as “Discharge standards of major pollutants for municipal wastewater treatment plant in Hunan” (DB43/T 1546-2018), which was implemented on Mar. 25, 2019. The above standards limit the concentration of major pollutants in discharged water, as shown in table 1. In addition, as the social progress, there is still a trend of continuous improvement of local discharge standards.

TABLE 1
Limit of discharge concentration of water pollutants

unit: mg/L

| | | Chemical | Ammonia- | Total | Total |
|---|---|---|---|---|---|
| Main control items | | Oxygen Demand | nitrogen ^{\textcircled{1}} | Nitrogen | Phosphorus |
| Discharge standards | First | 60 | 8(15) | 20 | 1 |
| of pollutants for | class B | | | | |
| municipal wastewater | First | 50 | 5(8) | 15 | 0.5 |
| treatment plants | class A | | | | |
| (GB18918-2002) | | | | | |
| Discharge standards | Second | 40 | 3.0(5.0) | 15 | 0.5 |
| of major pollutants | class | | | | |
| for municipal | First | 30 | 1.5(3.0) | 10 | 0.3 |
| wastewater treatment | class | | | | |
| plant in Hunan | | | | | |
| (DB43/T 1546-2018) | | | | | |

Note:
^{\textcircled{1}} The value outside the brackets is the control index when the water temperature is >12° C., and the value inside the brackets is the control index when the water temperature is <12° C.

To meet requirements of the current discharge standards, a conventional wastewater treatment process substantially include collecting the wastewater from a wastewater channel, and successively passing through a coarse screen and a lifting pump, a fine screen and a grit chamber, an A²/O biochemical tank, and a secondary sedimentation tank, then through a secondary lifting pump, a high-efficient clarification tank, a deep-bed denitrification filter, and a disinfection tank, eventually for reuse or discharge. The major problem of this wastewater treatment process is that there are too many treatment units, requiring multi-stage biochemical or physicochemical treatment of the wastewater. In addition, the long-path connection problem exists among the units, and the secondary lifting operation therefore is inevitable in the conventional wastewater treatment process, which resulting in the lengthy treatment and the high energy consumption.

### SUMMARY

In view of the above technical problems, the present invention provides a new biological fluidized bed process with high concentration powder carries used for the treatment of municipal wastewater with simple treatment and relatively low energy consumption.

The technical solution applied in the present invention is: a new biological fluidized bed process with high concentration powder carriers used for the treatment of municipal wastewater, wherein the biological fluidized bed comprises a HPB biochemical tank, a high-efficient clarification tank, a filter tank and a disinfection tank successively connected, wherein the process comprises the following steps:

(1) Flowing the wastewater through a coarse screen and a lifting pump firstly, lifting to a fine screen and a grit chamber, and then entering HPB biochemical tank;

(2) Dividing the HPB biochemical tank successively into an anaerobic zone, an anoxic zone, an aerobic zone and a concentrated separation zone along the flow direction of the wastewater, adding a compound powder carrier into the anaerobic zone, the anoxic zone and the aerobic zone respectively, and then stirring and mixing into a mixture;

(3) Transporting the mixture into the concentrated separation zone and concentrating and separating, wherein a concentrate returns back to the anaerobic zone, a supernatant from the concentrated separation zone is discharged and successively flows through the high-efficient clarification tank, the filter tank and the disinfection tank so as to purify, and the discharged excess sludge is transported to a compound powder carrier cyclone separation and recovery system;

(4) Separating the compound powder carrier by the compound powder carrier cyclone separation and recovery system;

(5) Adding the separated compound powder carrier to the HPB biochemical tank again;

(6) Dehydrating the residual part of the excess sludge for the next treatment, after recycling the compound powder carrier.

Preferably, the anaerobic zone, the anoxic zone, the aerobic zone and the concentrated separation zone are divided into several independent cells, each of which is separately controlled the water inflow and outflow by a runner and a gate valve, and is interconnected each other and equipped with a bypass valve.

Preferably, the HPB biochemical tank is equipped with a feeder, which is used to add the compound powder carrier to each of the cells in the anaerobic zone, the anoxic zone and the aerobic zone.

Preferably, each of the cells in the anaerobic zone, the anoxic zone and the aerobic zone is equipped with a stirring device, which is used for stirring the mixture in a corresponding cell.

Preferably, each of the cells in the concentrated separation zone is equipped with a concentrated machine, which is used to concentrate and separate the corresponding mixture.

Preferably, the compound powder carrier is formed by compounding the powder biological carrier and the alternative carbon source.

Preferably, the stirring device is an impeller agitator.

Preferably, an impeller of the impeller agitator is located in the bottom of the corresponding cell.

Preferably, each of the cells is a square with length of 2˜15 m, the water depth is 5˜8.5 m, the outer edge linear velocity of impeller is 1˜2 m/s, and the stirring power per unit volume of water is 3˜6 W/m³.

Preferably, the gate valve, the stirring device, a reflux pump for the concentrate, an internal reflux pump, the compound powder carrier cyclone separation and recovery system, the feeder and an aeration equipment are all precisely controlled and coordinated by a special centralized control system.

The beneficial effect of the invention:

(1) HPB is a new municipal wastewater treatment process, with only one lifting operation in the process. The major advantages of HPB include small land area requirement, low energy consumption and high pollutants removal efficiency.

(2) Based on the principle of wastewater treatment by A²/O process, adding a compound powder carrier in an activated sludge mixture in the biochemical tank for municipal wastewater treatment, not only improves the concentration of the sludge mixture, but also constructs a fluidized bed system in which a biofilm attached the compound powder carrier and a activated sludge in suspension growth are symbiotic “double sludge” in the same biological treatment system, which increase the microbial diversity of this system. Meanwhile, the system can improve the capacity of deep phosphorus and nitrogen removal in wastewater biological treatment by changing the control conditions. In order to avoid sedimentation of the compound powder carrier and to fully function the mixture in HPB biochemical tank, all cells are equipped with a stirring device, whereby the biofilm attached the compound powder carrier and the activated sludge in suspension growth in the mixture of HPB biochemical tank will be thoroughly mixed with the municipal wastewater to be treated by stirring and aerating. The stirring process would also strengthen convective mass transfer and improve the dissolved oxygen utilization rate by no less than 20%.

(3) The concentrated separation zone is connected to the end of the HPB biochemical tank. The concentrated solution reflux is used instead of the sludge reflux to ensure the stable concentration of the mixture in the system and avoid the burden of high-concentration mixture on a subsequent high-efficient clarification tank. The supernatant, as the effluent, from the concentrated separation zone enters the subsequent high-efficiency clarification tank and a filter tank to remove a small amount of residual suspended solids (SS) and control the total phosphorus, so as to ensure the effluent quality reaching the discharge standard.

(4) The HPB biochemical tank adopts modular design, and the wastewater treatment is carried out in each of the mutually independent cells. When the equipment needs maintenance or overhaul, it can be switched out separately by switching pipelines, valves or other bypass system settings, while the municipal wastewater treatment can still operate normally and continuously without affecting water discharge or reuse in discharge standard.

(5) Using recovery technology for compound powder carriers, may separate most of the compound powder carriers from the discharged excess sludge and then put them into the biochemical tank for recycling, which not only improve the utilization rate of the compound powder carriers, but also reduce the operating cost of HPB wastewater treatment.

(6) All gate valves, the stirring equipment, the concentrate reflux pump, the internal reflux pump, the compound powder carrier cyclone separation and recovery system, the feeder and the aeration equipment in the whole HPB biological treatment system are precisely controlled and coordinated by a special centralized control system.

### DESCRIPTION OF THE DRAWINGS

FIG. 1 is a block diagram of the structure according to the present invention.

FIG. 2 is a schematic diagram of the structure of HPB biochemical tank.

### DESCRIPTION OF THE EMBODIMENTS

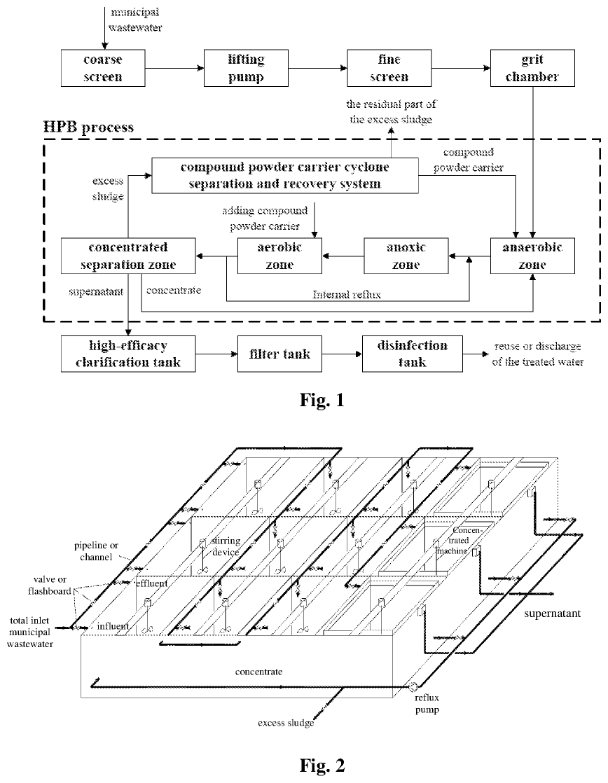

The following describes the present invention in detail with reference to FIG. 1 and FIG. 2. The schematic embodiments and descriptions of the present invention herein are used to explain the present invention, but are not intended to limit the present invention.

The present invention provides a new biological fluidized bed process with high concentration powder carriers used for the treatment of municipal wastewater, wherein the process comprises the following: the wastewater flows through a coarse screen (channel system) and a lifting pump firstly, then lifts to a fine screen and a grit chamber, and then enters a HPB biochemical tank. The HPB biochemical tank includes four functional zones, i.e., an Anaerobic zone, an Anoxic zone, an Oxic zone and a concentrated zone (A²/O/C for short). A compound powder carrier is added in the Anaerobic zone, the Anoxic zone and the Aerobic zone, respectively and stirred and mixed into a mixture. The mixture will flow into the concentrated separation zone and be concentrated and separated. The concentrate runs back into the anaerobic zone and subjects to a biological treatment again. The supernatant in the concentrated separation zone is discharged and passed through a high-efficient clarification tank, a filter tank and a disinfection tank successively for water purification, reaching the discharge standard or reuse. The discharged excess sludge is transported through a compound powder carrier cyclonic separation and recovery system. The compound powder carrier could be separated from the compound powder carrier cyclonic separation and recovery system. The separated compound powder carrier will be re-added to the HPB biochemical tank to realize the recycle of the compound powder carrier.

All gate valves, the stirring device, the concentrate reflux pump, the internal reflux pump, the compound powder carrier cyclone separation and recovery system, the feeder and the aeration equipment in the entire HPB biological treatment system are precisely controlled and coordinated by the special centralized control system, which highly elevates the smart level of the whole compound powder carrier fluidized bed system, furthermore reduces the operation cost and improves the wastewater treatment efficiency.

Specifically, the anaerobic zone, the anoxic zone, the aerobic zone and the concentrated separation zone in the present invention are divided into several independent cells, each of the cells is set to independent water inflow and outflow through runner and gate valves and is successively interconnected each other. Each cell is controlled by gate valves for independent water inflow and outflow and is equipped with a bypass valve, which can be shut down for checking or maintaining, without affecting the normal continuous operation of the system. The runner may be a pipeline or a channel, and the following uses a pipeline as an example for description: when the cell is operated normally, the gate valves of the inlet and outlet pipelines are opened at the same time, and the bypass valve is closed; during the maintenance or overhaul of the cell, the inlet and outlet pipelines are closed at the same time, and the bypass valve will be opened, and then the wastewater and the mixture can directly bypass the cell and directly enter into the subsequent cells. After the maintenance/overhaul of the cell, the valves of the inlet and outlet pipelines will be opened, while the bypass valve is closed to restore the normal inflow and outflow of water.

The HPB biochemical tank is successively divided into an anaerobic zone, an anoxic zone, an aerobic zone and a concentrated separation zone along the flow direction of the wastewater. While the wastewater enters the HPB biochemical tank, it is necessary to gradually introduce an appropriate amount of compound powder carriers and mix them with the activated sludge in the tank, so as to increase the concentration of the sludge mixture in the tank, and provide more carriers for the growth of the attached microorganisms, thereby increasing the biodiversity in the activated sludge, and realizing high-efficient removal of pollutants in the wastewater. To this end, a feeder is used to add the compound powder carrier to any of the cells in the anaerobic zone, the anoxic zone and the aerobic zone, which is beneficial to the growth of nitrifying bacteria and denitrifying bacteria, so that the system has an ability of deep removal of phosphorus and nitrogen in wastewater biological treatment.

In order to avoid the sedimentation of compound powder carriers and make full use of the function of the activated sludge in the HPB biochemical tank, all cells are equipped with a stirring device, by which the activated sludge in the mixture of the biochemical tank is stirred to being fully suspended and mixed, and the convective mass transfer and dissolved oxygen utilization rate may be improved. The stirring device is preferably an impeller agitator, and an impeller of each impeller agitator is preferably located in the bottom of the corresponding cell. Due to the fact that the sedimentation always occurs at the bottom of the tank, only a lower stirring power needs to be input at the bottom rather than agitating all water in the tank to effectively prevent sedimentation. According to “Code for design of outdoor wastewater engineering” (GB50014-2006), the sedimentation of the mixture is prevented with a minimum linear velocity of 0.6 m/s. Increasing the linear velocity can enlarge the disturbance, prevent the deposition of powder and improve the utilization rate of dissolved oxygen, but it will increase the energy consumption. Preferably, to achieve this equilibrium between the disturbance and the energy consumption, each cell is designed as a square with a side length of 2˜15 m, the water depth is 5˜8.5 m, the outer edge linear velocity of the impeller is 1˜2 m/s, and the stirring power per unit volume of water is 3˜6 W/m³. According to the formula recommended in “Water Supply and Drainage Design Manual”, the stirring power is related to the area of the paddle board or impeller. When the section size of the cell is 10 m×10 m and the water depth is 5.5 m, the water volume is 550 m³, the actual output power of the bottom hyperboloid mixer is 2.7 kw, and the input power per unit volume of water is 4.91 W/m³. Furthermore, it is demonstrated from the simulation tests that when the cell is a square with a side length of 2˜15 m, and the water depth is 5˜8.5 m, the linear velocity of outer edge of the impeller is 1˜2 m/s, and the stirring power per unit volume of water is 4˜6 W/m³, the dissolved oxygen utilization rate can be increased by 20%˜30%.

In general, the aeration and dissolving-oxygen process from the tank bottom is one that only micro-bubbles in the bottom rises to the surface of water, wherein the exchange rate of the dissolved oxygen in water is related to the linear rise rate of micro-bubbles, and the efficiency of dissolving oxygen is limited. After mechanical stirring, the micro-bubbles can rise along the vertical swirling field formed by the agitator, whereby the ascent path and hydraulic retention time are extended, and the dissolving-oxygen efficiency is improved. In the simulation tests, it is shown that the dissolving-oxygen efficiency in the spiral ascending process of the micro-bubbles in water can be increased by at least 20%˜30% or more.

A concentrated separation zone is disposed on the end of the HPB biochemical tank. Each of the cells in the concentrated separation zone is equipped with a concentrated machine for the concentration and separation of the mixture in the biological treatment tank, and the concentrate will run back into the inlet of the front anaerobic zone to maintain stability of mixture concentration and biological removal efficiency of phosphorus, while avoiding the burden of high-concentration mixture on the subsequent high-efficient clarification tank. The preferred manner is to recycle most of the concentrate and to pass the minor part as the excess sludge through the compound powder carrier cyclonic separation and recovery system, and to discharge and dehydrate the residue for the next treatment after recovery of the compound powder carrier. The concentrated and separated supernatant as the effluent enters the subsequent high-efficiency clarification tank to further remove a small amount of residual suspended solids (SS) in water and to control the total phosphorus, and then pass through the filter tank and the disinfection tank to be purified. The purified water may be discharged or reused reaching the discharge standard.

The HPB process in the present invention is a highly integrated process of municipal wastewater treatment, with only one-time lifting in the treatment process. In addition, it has small occupation area, low operating energy consumption and a daily treatment capacity of more than 10000 m³/d. As an embodiment of the present invention, the design parameters of the HPB biochemical tank can be that as follows: the plane view of each cell is a square with length of 2 m<L<15 m; the water depth of the cells is 5 m<h<8.5 m; the total hydraulic retention time HRT is about 10˜13 h; total variation coefficient Kz is about 1.5˜2.0. Taking the treatment capacity of 10000 m³/d for an example, the HPB biochemical tank is designed in 12 cells, wherein the size of each cell is 8.7 m×8.7 m, the effective water depth is 5.5 m, and the retention time is 12 h. The design of the tank type is shown in FIG. 2 in detail. The wastewater enters the HPB biochemical tank through pipelines or channels, and successively flows through the anaerobic zone (2 cells), the anoxic zone (1 cell), the aerobic region (6 cells), and the concentrated separation zone (3 cells) in vertical S-shape direction. The HPB biochemical tank in the embodiment has an external dimension of 27 m×27 m, followed by a high-efficient clarification tank with the surface loading rate of 6 m³/m²/h, a filter tank with a filtration speed of 15 m³/h/m², and a disinfection tank in order, and finally reusing or discharge after metering.

The invention also adopts a recovery process of compound powder carrier, and realizes accurate automatic control, thereby making the process system more energy saving and efficient. The control system can control gate valves and feeders according to the amount of municipal wastewater entering the system, which can not only accurately control the amount of the added compound powder carriers, but also control the treatment time of each cell, and thus greatly improving the treatment efficiency and saving the treatment cost. The compound powder carrier cyclone separation and recovery system uses a separator to recycle the compound powder carrier. Specially, the compound powder carrier in the present invention is formed by compounding the powder biological carrier and the alternative carbon source, wherein the ultra-fine powder as the alternative carbon source has a small diameter. However, the carrier to be recovered in the present invention is a particle with a relatively larger diameter. Since the ultra-fine powder “alternative carbon source” particles have large difference on both volume and weight from that of the carrier particles, the fine “alternative carbon source” particles are firmly absorbed on the surface of carrier particles based on an absorption advantage of the carrier particles for example big volume, great weight and large surface energy with respect to “alternative carbon source” particles. With this kind of asymmetric adsorption on the mass and surface, it is difficult for the “alternative carbon source” particles to overcome the repulsion energy peak and re-desorb it back into the water, thereby ensuring that the compound powder carriers together with the “alternative carbon source” and the attached biofilm are completely separated from the excess sludge. The aging biofilm debris peeled off from the compound powder carriers, the organic matter belonging to the proliferation part of activated sludge in suspension growth in the concentrated solution, the small part of the smaller carrier debris, and the microbial degraded ash have a smaller specific gravity, which has a large difference in specific gravity from the compound powder carriers. Using this difference in specific gravity, a cyclone separator can be used to separate them by controlling an appropriate swirling speed, and thus achieving the compound powder carriers with high recycling value and attached with microorganisms and ultra-fine powder “alternative carbon source”. The compound powder carrier cyclonic separation and recovery system not only improves the utilization rate of the compound powder carriers, but also reduces the processing cost.

The implementations above are only for the purpose of illustrating the present invention, and are not intended to limit the present invention. Those ordinary skilled in the relevant art may make various changes and modifications, without departing from the spirit and scope of the present invention. Therefore, all equivalent technical solutions should also belong to the scope of the present invention.

What is claimed is:

1. A new biological fluidized bed process with high concentration powder carriers used for the treatment of municipal wastewater, wherein the biological fluidized bed comprises a HPB biochemical tank, a high-efficient clarification tank, a filter tank and a disinfection tank successively connected, wherein the process comprises the following steps:
(1) Flowing the wastewater through a coarse screen and a lifting pump, lifting to a fine screen and a grit chamber, and then entering the HPB biochemical tank;
(2) Dividing the HPB biochemical tank successively into an anaerobic zone, an anoxic zone, an aerobic zone and a concentrated separation zone along the flow direction of the wastewater, adding a compound powder carrier into the anaerobic zone, the anoxic zone and the aerobic zone respectively, and then stirring and mixing into a mixture;
(3) Transporting the mixture into the concentrated separation zone and concentrating and separating, wherein a concentrate returns back to the anaerobic zone, a supernatant from the concentrated separation zone is discharged and successively flows through the high-efficient clarification tank, the filter tank and the disinfection tank so as to purify, and the discharged excess sludge is transported to a compound powder carrier cyclone separation and recovery system;
(4) Separating the compound powder carrier from the compound powder carrier cyclone separation and recovery system;
(5) Adding the separated compound powder carrier to the HPB biochemical tank again;
(6) Dehydrating the residual part of the excess sludge for the next treatment, after recycling the compound powder carrier.

2. The new biological fluidized bed process with high concentration powder carriers used for the treatment of municipal wastewater according to claim 1, wherein the anaerobic zone, the anoxic zone, the aerobic zone and the concentrated separation zone are all divided into several independent cells, each of which is separately controlled the water inflow and outflow by a water channels and a sluice valves, and is interconnected each other and equipped with a bypass valve.

3. The new biological fluidized bed process with high concentration powder carriers used for the treatment of municipal wastewater according to claim 2, wherein the HPB biochemical tank is equipped with a feeder, which is used to add the compound powder carrier to each of the cells in the anaerobic zone, the anoxic zone and the aerobic zone.

4. The new biological fluidized bed process with high concentration powder carriers used for the treatment of municipal wastewater according to claim 3, wherein each of the cells in the anaerobic zone, the anoxic zone and the aerobic zone is equipped with a stirring device, which is used for stirring the mixture in the corresponding cell.

5. The new biological fluidized bed process with high concentration powder carriers used for the treatment of municipal wastewater according to claim 2, wherein each of the cells in the concentrated separation zone is equipped with a concentrated machine, each of which is used to concentrate and separate a corresponding mixture.

6. The new biological fluidized bed process with high concentration powder carriers used for the treatment of municipal wastewater according to claim 1, wherein the compound powder carrier is formed by compounding the powder biological carrier and the alternative carbon source.

7. The new biological fluidized bed process with high concentration powder carriers used for the treatment of municipal wastewater according to claim 4, wherein the stirring device is an impeller agitator.

8. The new biological fluidized bed process with high concentration powder carriers used for the treatment of municipal wastewater according to claim 7, wherein an impeller of the impeller agitator is located in the bottom of the corresponding cell.

9. The new biological fluidized bed process with high concentration powder carriers used for the treatment of municipal wastewater according to claim 8, wherein each of the cells is a square with length of 2˜15 m, the water depth is 5˜8.5 m, the outer edge linear velocity of the impeller is 1˜2 m/s, and the stirring power per unit volume of water is 3˜6 W/m³.

10. The new biological fluidized bed process with high concentration powder carriers used for the treatment of municipal wastewater according to claim 4, wherein the gate valve, the stirring device, the compound powder carrier cyclone separation and recovery system and the feeder are precisely controlled and coordinated by a special centralized control system.
